(19) United States
(12) Patent Application Publication
(10) Pub. No.: US 2010/0146340 A1
(43) Pub. Date: Jun. 10, 2010

(54) Analyzing Coverage of Code Changes

(75) Inventors: AMIT ANIL BHATE, Pune (IN); CHANDRAJIT GANGADHAR JOSHI, Prune (IN); KRSTIN MARIE HAZLEWOOD, Austin, TX (US); RAMAKRISHNA JANARDHANA GORTHI, Pune (IN)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/330,832

(22) Filed: Dec. 9, 2008

(51) Int. Cl. G06F 11/36

(52) U.S. Cl. 714/38; 714/E11.207

(57) ABSTRACT

A method, system, and computer usable program product for analyzing test coverage of code changes are provided in the illustrative embodiments. A first source code is received. A second source code is received. The second code includes a changed code in comparison with the first source code. The changed code is identified. A set of test cases is executed on the second code. Information about the test coverage of the changed code is produced. Additionally, a determination may be made whether to produce code coverage information for the entire second source code or only the changed code. Using the set of test cases, code coverage information for the second source code may be computed, forming complete code coverage information. The information about the coverage of only the changed code may be selected from the complete code coverage information.

### BACKGROUND OF THE INVENTION

1. Field of the Invention

The present invention relates generally to an improved data processing system, and in particular, to a computer implemented method for analyzing a software application. Still more particularly, the present invention relates to a computer implemented method, system, and computer usable program code for analyzing code coverage of changes to the code of a software application.

2. Description of the Related Art

Software applications comprise program code. In some instances, a software application may include thousands of lines of code. Software developers test the program code of a software application before, during, and after the software application is deployed. For example, the code may be tested before deployment to ensure that the code performs as designed. The code may be tested as the software application is being deployed to, for example, trouble shoot a problem recognized during the application's deployment. The code may also have to be tested after the software has been deployed to, for example, add new features, continued troubleshooting of problems recognized post-deployment, or for customization for particular deployments.

The software developers may change, alter, modify, or augment the program code of a software application for a variety of reasons. For example, the developers may add new features, fix the identified bugs in the existing code, create alternate execution mechanisms, and change the code for many other reasons.

Testing tools are presently available to test the program code. Present testing tools can provide analytic information about the execution of the code. Software developers use these testing tools to determine the quality of the code, whether or not the code executes as desired, debugging the code, and executing the code under various test case scenarios.

### SUMMARY OF THE INVENTION

The illustrative embodiments provide a method, system, and computer usable program product for analyzing test coverage of code changes. A first source code is received. A second source code is received. The second code includes a changed code in comparison with the first source code. The changed code is identified. A set of test cases is executed on the second code. Information about the test coverage of the changed code is produced.

Additionally, a determination may be made whether to produce code coverage information for the entire second source code or only the changed code. Using the set of test cases, code coverage information for the second source code may be computed, forming complete code coverage information. The information about the coverage of only the changed code may be selected from the complete code coverage information.

Furthermore, the changed code may be changed lines of a source code, new lines of the source code, a changed function in the source code, a new function in the source code, or any combination thereof. The first and the second source codes are program codes written in a software programming language.

In one embodiment, the first and the second source codes may be one and the same and may be received only once. The changed code may be a designated portion of the second source code. The information about the coverage of only the changed code may include a percentage by which the changed code may have been exercised by the set of test cases.

In another embodiment, the first code may be a first sandbox build built from a backing build, second code may be a second sandbox build built using the first sandbox build as a new backing build. The first sandbox build may include a first changed code that may be different from the changed code.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a testing tool in which the illustrative embodiments may be implemented;

FIG. 4 depicts a block diagram of testing tool in operation in which the illustrative embodiments may be implemented;

FIG. 5 depicts a block diagram of a testing tool in accordance with an illustrative embodiment;

FIG. 6 depicts a block diagram of an improved testing tool operating in accordance with an illustrative embodiment; and

FIG. 7 depicts a flowchart of a process of determining code coverage of changed code in accordance with an illustrative embodiment.

### DETAILED DESCRIPTION OF THE PREFERRED EMBODIMENT

Unit testing of a program code is the process of testing portions of the program code. Unit testing of a program code uses a set of test cases. A set of test cases is one or more test cases. A test case is a test designed to cause a portion of the program code to execute or a particular function of the program code to occur.

The unit testing and the test cases are deemed to be of good quality if the unit testing covers most of the program code. Covering, or coverage of, a portion of program code is executing the lines of code in that portion of the program code.

Code coverage is a measurement produced by the testing tools that inform a user about how much of the code has been exercised using a given set of test cases. Exercising a portion or line of code is executing that portion or line of code. Generally, testing tools provide code coverage as a percentage. The percentage value of code coverage reflects the fraction—amount of code exercised over the total code available.

The illustrative embodiments recognize that the higher the code coverage percentage, the more likely it is that a bug or error in the code will be identified during the unit testing. Consequently, the illustrative embodiments recognize that the higher the code coverage percentage, the better the quality of the test cases and the better the quality of the tested code.

The illustrative embodiments recognize that give a program code, a presently available testing tool provides code coverage value relative to the entire code that is being tested. As an example, if the total program code includes one hundred lines and ten lines of code were exercised, the present testing tools will provide a code coverage value of ten percent. As another example, if the total program code included ten functions, and two functions were exercised, the present testing tools will provide a code coverage value of twenty percent.

The illustrative embodiments recognize that when only a portion of the program code is to be tested, such code coverage values fail to disclose whether the changed portion of the code has been covered. Using the above examples, if the program code was a total of one hundred lines of code and ten lines were changed, a code coverage value of ten percent will leave a programmer wondering if the ten lines that were exercised were indeed the changed lines of code or some other ten lines of code.

As another example, assume that one of the ten functions in a program code was to be tested. A code coverage value of ten percent would again confuse the programmer as to whether the ten percent code coverage resulted from the execution of the changed function or some other function.

In programming context, a sandbox is a development area of a data processing system where developers incrementally build and test code. A sandbox build is a collection, or build, of code that is to be tested in a sandbox setup. Developers build and test enhancements, modifications, or other changes to code in a sandbox build. A backing build is a collection, or build, of original program code, from which the incremental changes of the sandbox build are made.

The illustrative embodiments recognize that present testing tools provide the code coverage information based on the presumption that the entire code of a sandbox build has to be traversed and the code coverage percentage generated relative to the entire sandbox build code. Some other testing tools do generate code coverage information for the changed portions of the code, but they generate the information by comparing the code coverage of the sandbox build to a previously computed code coverage of a backing build. Running test cases on a backing build to generate this base information can be expensive and time consuming.

Thus, some presently available testing tools do not provide information that is specific to the changed or designated code potions. Other presently available testing tools compare different test runs. These testing tools require a prior computation of code coverage of the backing build to provide changed code specific code coverage information.

To address these and other related problems, the illustrative embodiments provide a method, computer usable program product, and data processing system that when used in conjunction with a testing tool will provide code analysis including code coverage information of the changed or designated portion of a program code. If, for example, ten lines of code is changed in a one hundred line program code, the illustrative embodiments can provide code coverage of the changed ten lines.

In this example, a test case may exercise all ten of the changed lines. A presently available tool may provide that the code coverage is ten percent, whereas the illustrative embodiments may provide that the code coverage is one hundred percent of the changed code. Thus, using the illustrative embodiments, a developer or a tester may receive accurate information that is relevant to the changed or designated portion of the code and not relative to a build of the entire code.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

The illustrative embodiments are described in some instances using particular data processing environments only as an example for the clarity of the description. The illustrative embodiments may be used in conjunction with other comparable or similarly purposed architectures for using virtualized real memory and managing virtual machines.

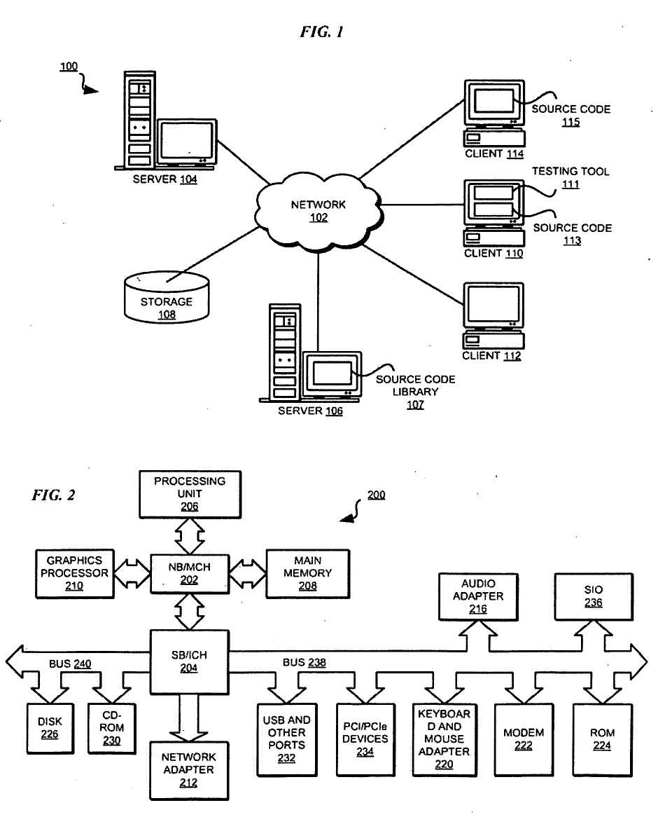

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108.

Software applications may execute on any computer in data processing environment 100. Server 106 may have a software application, source code library 107, executing thereon. Source code library 107 may store and manage source code for backing builds, sandbox builds, or both, Source code library 107 may utilize storage 108 over network 102. In the depicted example, client 110 may include testing tool 111. Testing tool 111 may test source code 113 that may be executing on client 110. Testing tool 111 may also test source code 115 that may be executing on client 114. Source codes 114 and 115 may be source code portions retrieved from source code library 107, or modified from source code stored in source code library 107.

Source code library 107, testing tool 111, source code 113, source code 115 may each be executed on any data processing system or any combination of client and server data processing systems in data processing environment 100 without departing from the scope of the illustrative embodiments. In one embodiment, tested application 105 may execute on client 112 and profiler application 111 may execute on server 104 or client 114. In another embodiment, tested application 105 and profiler application 111 may execute on a common data processing system, such as client 110 or server 104.

In addition, clients 110, 112, and 114 couple to network 102. Servers 104 and 106, storage units 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions, for the operating system, the object-oriented programming system, and applications or programs are located on storage devices, such as hard disk drive 226, and may be loaded into main memory 208 for execution by processing unit 206. The processes, of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

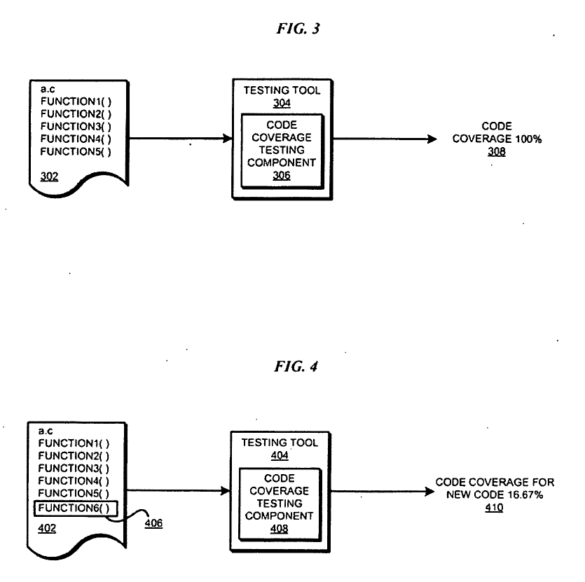

With reference to FIG. 3, this figure depicts a block diagram of a testing tool in which the illustrative embodiments may be implemented. Code 302 may be source code 113 or 115 in FIG. 1. Testing tool 304 may testing tool 111 in FIG. 1.

Code 302 may be, for example, source code named “a.c” created in “C” programming language. Source code a.c may include several functions, for example, function1( ) function2( ) function3( ) function4( ) and function5( ).

Testing tool 304 may include code coverage testing component 306. Executing code 302 using testing tool 304 may generate result 308. For a particular test case, the entire source code of code 302 may be executed. Consequently, result 308 may show that the code coverage of code 302 is one hundred percent, to with, all of the source code in code 302 has been exercised.

With reference to FIG. 4, this figure depicts a block diagram of testing tool in operation in which the illustrative embodiments may be implemented. Code 402 may be code 302 in FIG. 3. Testing tool 404 may testing tool 304 in FIG. 3.

Code 402 may be, continuing with the example of code 302 in FIG. 3, source code named “a.c” created in “C” programming language. Source code a.c may include several functions, for example, function1( ) function2( ) function3( ) function4( ) and function5( ) Code 402 may further include code 406, for example, a new function—function6( ).

Testing tool 404 may include code coverage testing component 408, which may be similar to code coverage testing component 306 in FIG. 3. Executing code 402 using testing tool 404 may generate result 410. For a particular test case, the source code of code 406 may be executed. Consequently, result 410 may show, without the benefits of the illustrative embodiments, that the code coverage of code 402 is approximately sixteen and one sixty seventh percent. Without the benefits of the illustrative embodiments, result 410 may thus fail to inform a tester whether or not function6( ) was exercised by the test case.

With reference to FIG. 5, this figure depicts a block diagram of a testing tool in accordance with an illustrative embodiment. Testing tool 500 may be implemented using testing tool 404 in FIG. 4.

Testing tool 500 may include code coverage testing component 502, which may be similar to code coverage testing component 408 in FIG. 4. Testing tool 500 may further include according to an illustrative embodiment, change identification component 504.

Furthermore, testing tool 500 may include one or more features that may permit operating testing tool in the conventional mode or sandbox mode. For example, in a conventional mode, testing tool may provide code coverage information for the entire source code of the build. In a sandbox mode, for example, testing tool 500 may use change identification component 504 to identify the changed areas of the source code and provide code coverage information relative to the changed code only.

In one embodiment, a user, may be able to designate a portion of the source code for which the user may want code coverage information. Note that change identification component 504 may operate to allow automatic or manual identification of changed code portions, or allow a user or application to designate a code portion for code coverage testing.

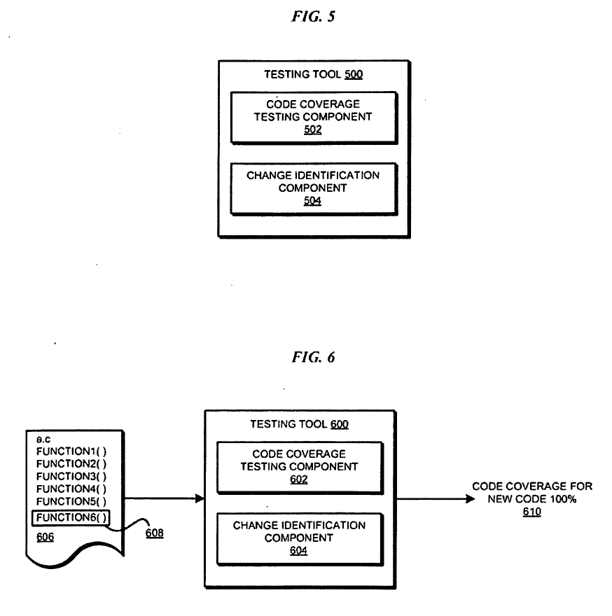

With reference to FIG. 6, this figure depicts a block diagram of an improved testing tool operating in accordance with an illustrative embodiment. Testing tool 600 may be implemented using testing tool 500 in FIG. 5. Code coverage testing component 602 and change identification component 604 may be similar to the corresponding components in FIG. 5.

Code 606 may be, continuing with the example of code 402 in FIG. 4, source code named “a.c” created in “C” programming language. Source code a.c may include several functions, for example, function1( ) function2( ) function3( ) function4( ) and function5( ). Code 604 may further include code 608, for example, a new function-function6( ).

In accordance with the illustrative embodiments, code 604 may be tested for code coverage of code 608 using testing tool 600 in a sandbox mode. A test case used as an example may exercise function6( ) of code 608. Accordingly, result 610 may indicate that the code coverage of code 608 in code 604 is one hundred percent. A user testing code 604 may be confident that code 608, that may have been newly added, changed, or otherwise designated, has been completely exercised.

In comparison, as in FIG. 4, result 410 informed that the code coverage was approximately sixteen and one sixty seventh percent. In such a case, without the illustrative embodiments, the user would have been uncertain whether function6( ) ever got exercised during the testing.

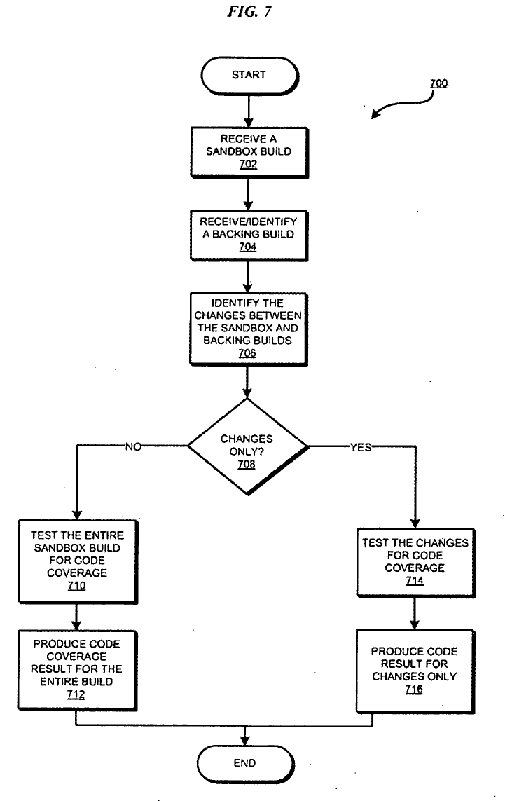

With reference to FIG. 7, this figure depicts a flowchart of a process of determining code coverage of changed code in accordance with an illustrative embodiment. Process 700 may be implemented in testing tool 600 in FIG. 6.

Process 700 begins by receiving a sandbox build (step 702). Process 700 also receives a backing build (step 704). As described above, the sandbox build of step 702 may use the code of a corresponding backing build of step 704 and may include some code changes.

Process 700 may identify the changes between the sandbox build and the backing build (step 706). For example, process 700 may utilize the processing of a change identification component, such as change identification component 604 in FIG. 6, to perform step 706.

Process 700 determines whether to test for code coverage of the changes only (step 708). In other words, process 700 may determine whether to operate in the conventional mode or the sandbox mode as described above. If process 700 determines to operate in the conventional mode (“No” path of step 708), process 700 tests the entire code of the sandbox build for code coverage (step 710). Process 700 produces code coverage results for the entire build (step 712). Process 700 ends thereafter.

If process 700 determines to operate in the sandbox mode (“Yes” path of step 708), process 700 tests the code changes of the sandbox build for code coverage (step 714). Process 700 produces code coverage results for the changed code only from the sandbox build (step 716). Process 700 ends thereafter.

While process 700 is described with respect to testing for code coverage of code that may have changed between builds, it will be apparent to those skilled in the art to modify process 700 for testing for code coverage of designated portions of code. For example, in lieu of steps 702, 704, and 706, one or more steps in process 700 may identify a portion of the source code. Some other step in lieu of step 708 may determine whether to test the entire code or just the identified portion. The modified process 700 may then produce code coverage results according to the selections. Such modifications are contemplated within the scope of the illustrative embodiments.

The components in the block diagrams and the steps in the flowcharts described above are described only as examples. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments for analyzing coverage of code changes. Using the illustrative embodiments, a code coverage testing tool may be able to analyze and produce code coverage results for only the portions of the source code that may have changed.

The illustrative embodiments produce results that indicate to a user whether or not the changed code has been covered by a test case. A user can also use the illustrative embodiments to designate a portion of code for coverage testing and obtain similar results.

The illustrative embodiments allow the users to avoid having to test an entire backing build, test the entire sandbox build, and then compare the results to predict whether the changed code has been exercised. The illustrative embodiments also allows the users to learn only the code coverage results of the changed or designated code and not the results pertaining to the rest of the code in the build.

Upon identifying the changed or designated portion of the code to be tested, a testing tool according to the illustrative embodiments may create or process the code coverage results of the test cases. Such creating or processing of the results, such as by retaining the code coverage data relating to the changed code and discarding the rest, may be one way in which the illustrative embodiments may deliver the targeted code coverage results.

Furthermore, the illustrative embodiments can be used in an incremental software development process where a sandbox build may be built within another sandbox build. For example, a first sandbox build might change a first function of a backing build. In a first analysis, the illustrative embodiments may provide the code coverage analysis of the code changes in that first function. A second sandbox build may further change the code of a second function using the first sandbox build as a backing build. In a second analysis, the illustrative embodiments may provide the code coverage analysis of only the changes to the second function and considering the changes to the first function as a part of the backing build. Any number of nested sandbox builds may thus be analyzed using the illustrative embodiments.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for analyzing test coverage of code changes, the computer implemented method comprising:
receiving a first source code;
receiving a second source code, wherein the second code includes a changed code in comparison with the first source code;
identifying the changed code;
executing a set of test cases on the second source code;
producing information about the test coverage of the changed code.

2. The computer implemented method of claim 1, further comprising:
determining whether to produce code coverage information for one of (i) the second source code and (ii) the changed code.

3. The computer implemented method of claim 1, further comprising:
computing, using the set of test cases, code coverage information for the second source code, forming complete code coverage information; and
selecting from the complete code coverage information, the information about the coverage of only the changed code.

4. The computer implemented method of claim 1, wherein the changed code is one of (i) changed lines of a source code, (ii) new lines of the source code, (iii) a changed function in the source code, and (iv) a new function in the source code, and wherein the first and the second source codes are program codes written in a software programming language.

5. The computer implemented method of claim 1, wherein the first and the second source codes are one and the same and received only once, and wherein the changed code is a designated portion of the second source code.

6. The computer implemented method of claim 1, wherein the information about the coverage of only the changed code includes a percentage by which the changed code has been exercised by the set of test cases.

7. The computer implemented method of claim 1, wherein the first source code is a first sandbox build built from a backing build, the second source code is a second sandbox build built using the first sandbox build as a new backing build, and wherein the first sandbox build includes a first changed code, the first changed code being different from the changed code.

8. A computer usable program product comprising a computer usable medium including computer usable code for analyzing test coverage of code changes, the computer usable code comprising:
computer usable code for receiving a first source code;
computer usable code for receiving a second source code, wherein the second code includes a changed code in comparison with the first source code;
computer usable code for identifying the changed code;
computer usable code for executing a set of test cases on the second source code;
computer usable code for producing information about the test coverage of the changed code.

9. The computer usable program product of claim 8, further comprising:
computer usable code for determining whether to produce code coverage information for one of (i) the second source code and (ii) the changed code.

10. The computer usable program product of claim 8, further comprising:
computer usable code for computing, using the set of test cases, code coverage information for the second source code, forming complete code coverage information; and
computer usable code for selecting from the complete code coverage information, the information about the coverage of only the changed code.

11. The computer usable program product of claim 8, wherein the changed code is one of (i) changed lines of a source code, (ii) new lines of the source code, (iii) a changed function in the source code, and (iv) a new function in the source code, and wherein the first and the second source codes are program codes written in a software programming language.

12. The computer usable program product of claim 8, wherein the first and the second source codes are one and the same and received only once, and wherein the changed code is a designated portion of the second source code.

13. The computer usable program product of claim 8, wherein the information about the coverage of only the changed code includes a percentage by which the changed code has been exercised by the set of test cases.

14. The computer usable program product of claim 8, wherein the first source code is a first sandbox build built from a backing build, the second source code is a second sandbox build built using the first sandbox build as a new backing build, and wherein the first sandbox build includes a first changed code, the first changed code being different from the changed code.

15. A data processing system for analyzing test coverage of code changes, the data processing system comprising:
a storage device including a storage medium, wherein the storage device stores computer usable program code; and
a processor, wherein the processor executes the computer usable program code, and wherein the computer usable program code comprises:
computer usable code for receiving a first source code;
computer usable code for receiving a second source code, wherein the second code includes a changed code in comparison with the first source code;
computer usable code for identifying the changed code;
computer usable code for executing a set of test cases on the second source code;
computer usable code for producing information about the test coverage of the changed code.

16. The data processing system of claim 15, further comprising:
computer usable code for determining whether to produce code coverage information for one of (i) the second source code and (ii) the changed code.

17. The data processing system of claim 15, further comprising:
computer usable code for computing, using the set of test cases, code coverage information for the second source code, forming complete code coverage information; and
computer usable code for selecting from the complete code coverage information, the information about the coverage of only the changed code.

18. The data processing system of claim 15, wherein the changed code is one of (i) changed lines of a source code, (ii) new lines of the source code, (iii) a changed function in the source code, and (iv) a new function in the source code, and wherein the first and the second source codes are program codes written in a software programming language.

19. The data processing system of claim 15, wherein the first and the second source codes are one and the same and received only once, and wherein the changed code is a designated portion of the second source code.

20. The data processing system of claim 15, wherein the information about the coverage of only the changed code includes a percentage by which the changed code has been exercised by the set of test cases.
